(19) United States
(12) Patent Application Publication
(10) Pub. No.: US 2016/0347531 A1
(43) Pub. Date: Dec. 1, 2016

(54) INSULATED PACKAGE SYSTEM, INSERT PANELS THEREFOR, AND METHOD OF ASSEMBLY

(71) Applicant: Craig John Becker, Honolulu, HI (US)

(72) Inventor: Craig John Becker, Honolulu, HI (US)

(21) Appl. No.: 14/727,099

(22) Filed: Jun. 1, 2015

(51) Int. Cl. B65D 81/38; B65D 5/64; B31B 3/00; B65D 5/02

(52) U.S. Cl. CPC B65D 81/3813; B65D 81/3825; B65D 81/3848; B65D 5/02; B65D 5/64; B31B 3/00

(57) ABSTRACT

Insulated package systems, components for such systems, and methods for their assembly and use. The systems include insert panels that are configured to be disposed within an interior volume of a container alongside walls thereof so as to define and enclose an insulated shipping compartment within the interior volume. At least one of insert panels includes a tray portion having a base wall that defines an inner face of the insert panel, and a lid portion having a base wall that optionally defines a recessed pocket exposed at an outer face of the insert panel. An enclosed pocket is disposed between the base walls of the tray and lid portions, and may be filled with an insulation material.

### BACKGROUND OF THE INVENTION

The present invention generally relates to containers suitable for shipping articles. The invention particularly relates to insulated package systems suitable for transporting, handling, and/or storing temperature-sensitive materials, goods, produce, etc., and to methods of assembling insulated package systems.

Various types of insulated containers have been developed for the purpose of transporting and handling materials, goods, produce, etc. Such containers, which as used herein refer to boxes, cartons, bins, mailers, packages, coolers, etc., having closable interior cavities, have been manufactured from blanks formed of various sheet materials, corrugated cardboard for example, which can be converted by folding, taping, gluing, fastening, etc., into a variety of desired configurations. Different manufacturing processes, including modifications in the container configuration and the sheet material from which the container is converted, have been used and proposed for producing a variety of containers adapted to ship a wide range of products.

For the purpose of transporting and handling temperature-sensitive materials, goods, produce, etc., numerous attempts have been made to produce insulated containers that utilize various board materials, which as used herein generally refers to stiffened sheet materials including, but not limited to, corrugated cardboard, linerboard, corrugated fiberboard, laminated board, containerboard, boxboard, paperboard, etc. Prior attempts have often suffered from complexity of design, which can create manufacturing issues and/or result in inefficient use of raw materials, such that excessive board materials are used in production leading to excessive waste and increased final product costs. As an example, certain designs can be excessively complex for setup by an end user because of the number of pieces, the manner in which the pieces are interlocked, the need for additional use of foam strips, coatings, chemical barriers, inserts, etc.

Furthermore, insulated container designs that require the use of additional materials such as foam strips, coatings or chemical barriers are generally not recyclable because the additional materials are an integral part of the board material. Removal of foam strips, coatings and barriers is often impossible or too difficult, time-consuming, or expensive to warrant removal by the end user.

Additional issues encountered with prior insulated container designs include the difficulty of placing and securing separate insulation materials. For example, in designs utilizing insulation materials disposed between walls of an outer container and an insert placed in the container, the insulation material is not locked or otherwise positively secured to the container or insert. In instances where the insulation material is a loose fill material, for example, Styrofoam “peanuts,” a “fluff” fill material such as shredded waste paper, newspaper, cotton fiber, coconut husks, other cellulosic material, or any other light weight and flexible material, the insulation material is subject to severe settlement toward the bottom of the container during shipping which reduces the thermal protection for product located near the top of the container. On the other hand, if additional insulation material is used to prevent or reduce settling, the additional weight of the insulation material can negatively impact the end user's freight charges to deliver the product to the market.

In view of the above, it can be appreciated that there are certain problems, shortcomings or disadvantages associated with insulated package systems of the prior art, and it would be desirable if package systems were available that were capable of at least partly overcoming or avoiding these problems, shortcomings, and disadvantages.

### BRIEF DESCRIPTION OF THE INVENTION

The present invention provides insulated package systems suitable for transporting, handling, and/or storing temperature-sensitive materials, goods, produce, etc., as well as components for such systems and methods for their assembly.

According to one aspect of the invention, insert panels are provided that are configured to be disposed within an interior volume of a container alongside walls thereof so as to define and enclose an insulated shipping compartment within the interior volume. At least a first of the insert panels comprises a tray portion having a base wall that defines an inner face of the first insert panel, and a lid portion having a base wall that defines an outer face of the first insert panel that is oppositely-disposed to the inner face. An enclosed pocket is disposed between the base walls of the tray and lid portions and within the first insert panel.

According to another aspect of the invention, an insulated package system is provided that comprises a container having container side panels, container end panels, a closed bottom wall, and an opening closable with a top wall to enclose an interior volume of the container. The system further comprises insert panels that are disposed within the interior volume of the container alongside the container side panels, container end panels, bottom wall, and top wall of the container so as to define and enclose an insulated shipping compartment within the interior volume. Each of the insert panels comprises a tray portion, a lid portion, and oppositely-disposed inner and outer faces. The inner faces face inward toward the insulated shipping compartment, and the outer faces face outward toward a corresponding one of the container side panels, container end panels, bottom wall, and top wall of the container. The tray portion has a base wall that defines the inner face of its corresponding insert panel. The lid portion has a base wall at the outer face of its corresponding insert panel. The base walls of the tray and lid portions of at least a first of the insert panels define therebetween an enclosed pocket within its corresponding insert panel.

Other aspects of the invention include methods of constructing one or more of the insert panels described above and constructing the insulated package system described above.

An optional but preferred aspect of the invention is that at least one of the insert panels further contains an insulation material within its enclosed pocket, whereas an optional recessed pocket exposed at the outer face of the insert panel may but preferably does not contain an insulation material. The insulation material may be, for example, a fluff material that can be compressed between the base walls of the tray and lid portions of the insert panel.

Technical effects of insulated package systems as described above preferably include the capability to quickly construct insert panels from precut blanks, and to simultaneously create at least one and preferably multiple separate pockets within each insert panel that may contain only air as a thermal barrier or contain a solid insulation material. A preferred aspect of such systems is that an insert panel can be constructed and configured to inhibit settling of a solid insulation material present within its pocket or pockets. Various solid insulation materials can be used, including bubble wrap of variable thicknesses, foils including reflective foils, cotton or clothe filler materials that are spun or layered, various dry organic materials such as plant husks or fibers, etc. Another preferred aspect of insulated package systems as described above is the ability of the systems, including its insert panels and any solid insulation material, to be constructed entirely of recyclable materials, such that disassembly of the systems and their components is not required prior to recycling.

Other aspects and advantages of this invention will be better appreciated from the following detailed description.

### BRIEF DESCRIPTION OF THE DRAWINGS

FIG. 1A is a perspective view of a regular slotted carton (RSC) box that can be used with embodiments of this invention, and FIG. 1B represents a plan view of a one-piece unitary blank configured for constructing the box of FIG. 1A.

FIG. 2 is a perspective view of a two-piece design style tray (DST) box that can be used with embodiments of this invention.

FIG. 3 schematically represents a cross-sectional view of the box of FIG. 1A, following the installation of side, end, bottom, and top insert panels to create an insulated shipping compartment within the box, wherein each insert panel comprises an enclosed pocket that contains a loose fill insulation material, and a recessed pocket that contains only air.

FIGS. 4 and 5 are perspective and cross-sectional views of a representative insert panel for the side, end, bottom, and top insert panels depicted in FIG. 3.

FIG. 6 is a plan view of a one-piece unitary blank configured for constructing the representative insert panel depicted in FIGS. 4 and 5, and adapted for assembly with the box of FIG. 1A as represented in FIG. 3.

FIG. 7 represents a fragmentary plan view of an enclosed pocket of an insert panel and a portion of an interlocking grid structure within the pocket to promote the strength of the insert panel.

FIGS. 8 and 9 represent plan views of two separate blanks configured for constructing two different elements of the interlocking grid structure of FIG. 7.

### DETAILED DESCRIPTION OF THE INVENTION

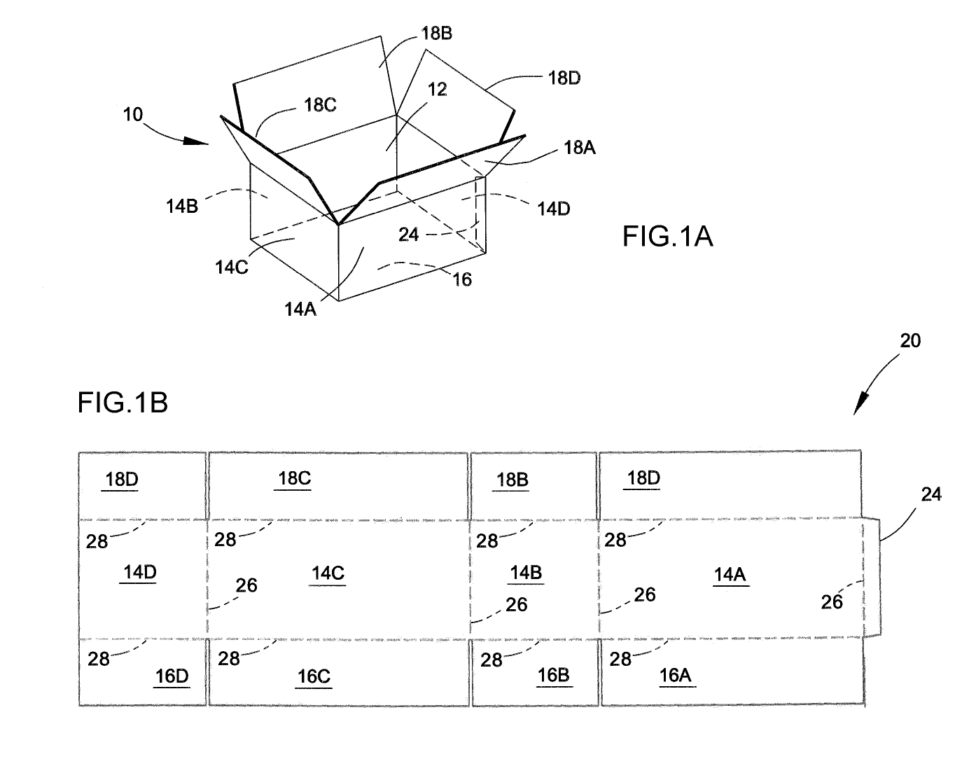

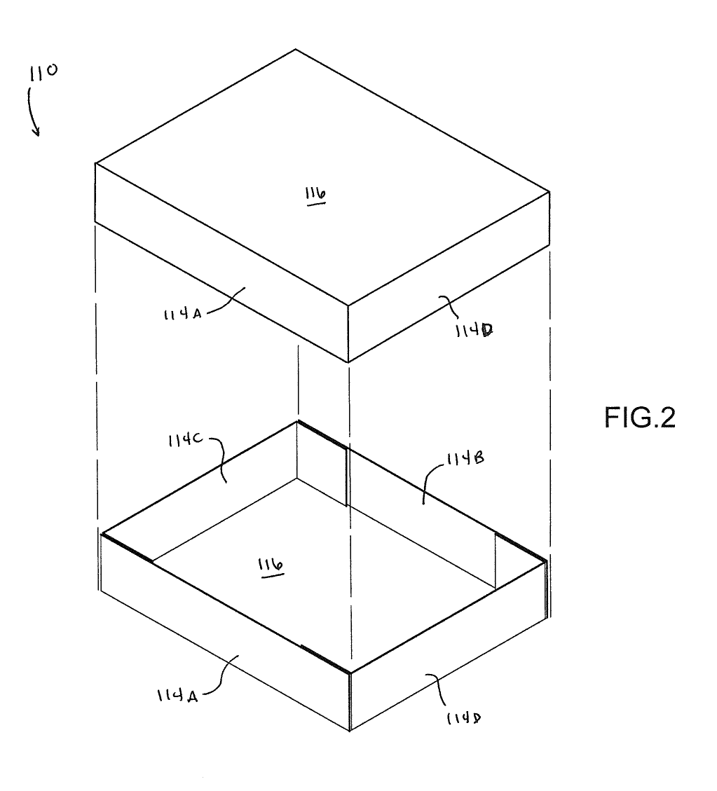

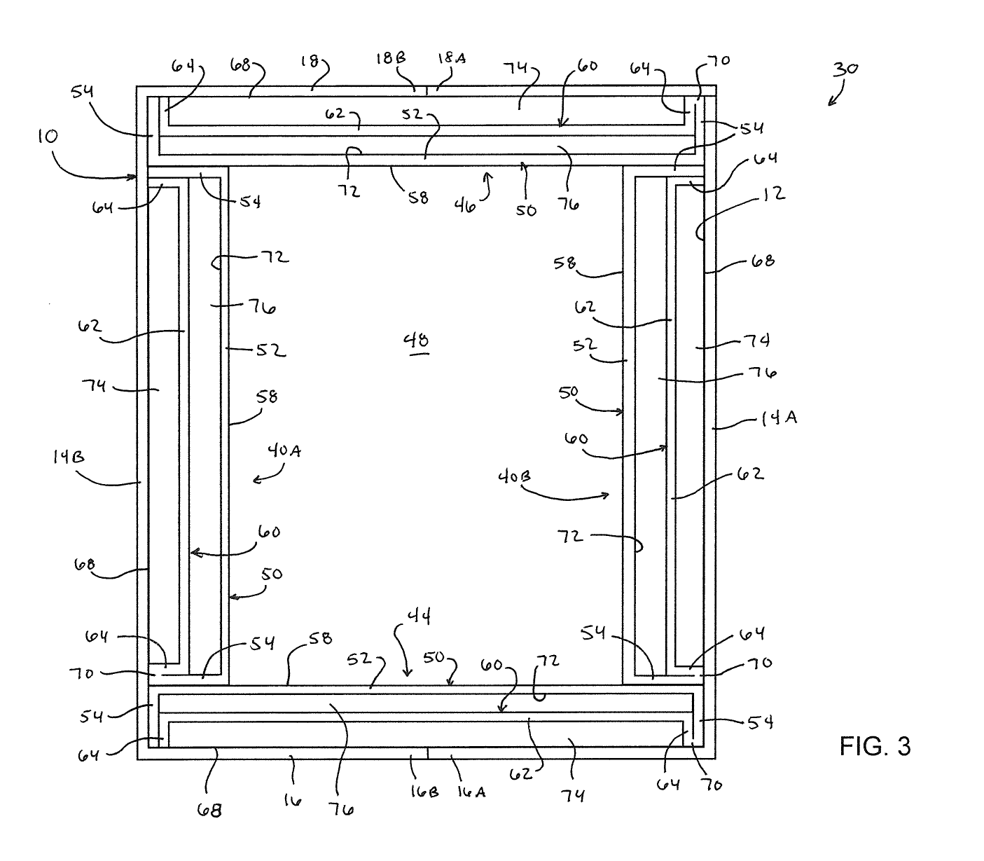

FIGS. 1 through 9 represent various aspects and components of an insulated package system 30 (FIG. 3) that can be constructed in accordance with a nonlimiting embodiment of the invention. Although the invention will be primarily described hereinafter in reference to a regular slotted carton (RSC) box shown in FIG. 1A, it will be appreciated that the teachings of the invention are more generally applicable to other types of containers as well, for example, a design style tray (DST) box shown in FIG. 2.

The insulated package system 30 represented in FIG. 3 and its components represented in FIGS. 3, 4, and 5 are preferably adapted to provide thermal protection for a wide variety of temperature-sensitive materials, goods, produce, etc., during transport, handling, and/or storage. The system 30 is also preferably capable of being entirely manufactured from recyclable materials, such that removal of nonrecyclable materials prior to recycling of the system 30 can be avoided or significantly reduced.

FIG. 1A represents a container 10 of a type that can be constructed from a single unitary blank 20 of sheet material represented in FIG. 1B. The container 10 is represented as having the general configuration of an RSC box characterized by an interior volume 12 having the shape of a rectangular parallelepiped or cuboid. The interior volume 12 is defined by two container side panels 14A and 14B, two container end panels 14C and 14D, four bottom flaps 16A-D (not visible in FIG. 1A) that form the bottom wall 16 of the container 10, and four top flaps 18A-D that are adapted to be folded to close an opening of the container 10, enclose the interior volume 12, and form the top wall 18 (FIG. 3) of the container 10. The container panels 14A, 14B, 14C and 14D, the bottom wall 16, and the top wall 18 of the container 10 are at times referred to as the walls of the container 10. To facilitate the descriptions of the container 10 and the blank 20 provided below, the terms “top,” “bottom,” “side,” “end,” etc., will be used in reference to the perspective of the orientation of the container 10 in FIG. 1A, and therefore are relative terms and should not be otherwise interpreted as limitations to the construction and use of the container 10 or the blank 20 of sheet material.

FIG. 1B shows a surface 22 of the blank 20 that, when converted to form the container 10 of FIG. 1A, defines the exterior-facing surfaces of the container 10. As evident from FIG. 1B, the blank 20 has been cut, such as with a die, to define the container panels 14A-D and flaps 16A-D and 18A-D of the container 10. In particular, the blank 20 comprises the two side panels 14A and 14B, the two end panels 14C and 14D, the four bottom flaps 16A-D that form the bottom wall 16 of the container 10, and the four top flaps 18A-D that define the closing flaps of the container 10. An additional flap, referred to as a stitch tab 24, extends from the container end panel 14D which, as evident from FIG. 1A, enables the container panel 14A to be glued or otherwise attached to the container side panel 14A for closing the perimeter of the container 10. The blank 20 can be manufactured and configured to promote the structural integrity of the container 10 constructed (converted) from the blank 20. In preferred embodiments, the blank 20 is a linerboard material, though it is foreseeable that other board materials could be used in its construction. The container 10 can be fabricated by folding the blank 20 according to known practices in the industry, as exemplified by the scores 26 between the container panels 14A-D and the scores 28 between each container panel 14A-D and its corresponding flaps 16A-D and 18A-D.

As noted above, other types of containers can be utilized with the present invention, including the DST container 110 represented in FIG. 2. The container 110 comprises a bottom 110A and cover 110B that are sized so that, after assembly, one at least partially fits inside the other, for example, the bottom 110A is sized to nest closely within the cover 110B so that container side panels 114A, 114B, 114C and 114D of the cover 110B surround at least the upper portions of the adjacent container side panels 114A, 114B, 114C and 114D of the bottom 110A. In addition, the panels 114A, 114B, 114C and 114D and base walls 116 of the bottom 110A and cover 110B cooperate to define an interior volume within the container 110 having the shape of a rectangular parallelepiped or cuboid. The bottom 110A and cover 110B can each be individually constructed from a separate unitary blank of sheet material (not shown).

Other aspects of containers and sheet materials such as those represented in FIGS. 1A, 1B, and 2 would be generally known to those in the industry, and therefore will not be discussed in any further detail here.

The insulated package system 30 is represented in FIG. 3 as comprising the container 10 of FIG. 1A and six insert panels 40A, 40B, 42A, 42B, 44, and 46 that are sized and configured to be placed in the container 10 to create an insulated shipping compartment 48 within the container 10. In the following discussion, the insert panels 40A, 40B, 42A, 42B, 44, and 46 will be identified as two side insert panels 40A and 40B, two end insert panels 42A and 42B, a bottom insert panel 44, and a top insert panel 46. Each insert panel 40A, 40B, 42A, 42B, 44, and 46 can be fabricated, for example, from one or more blanks formed of linerboard stock or other suitable board material.

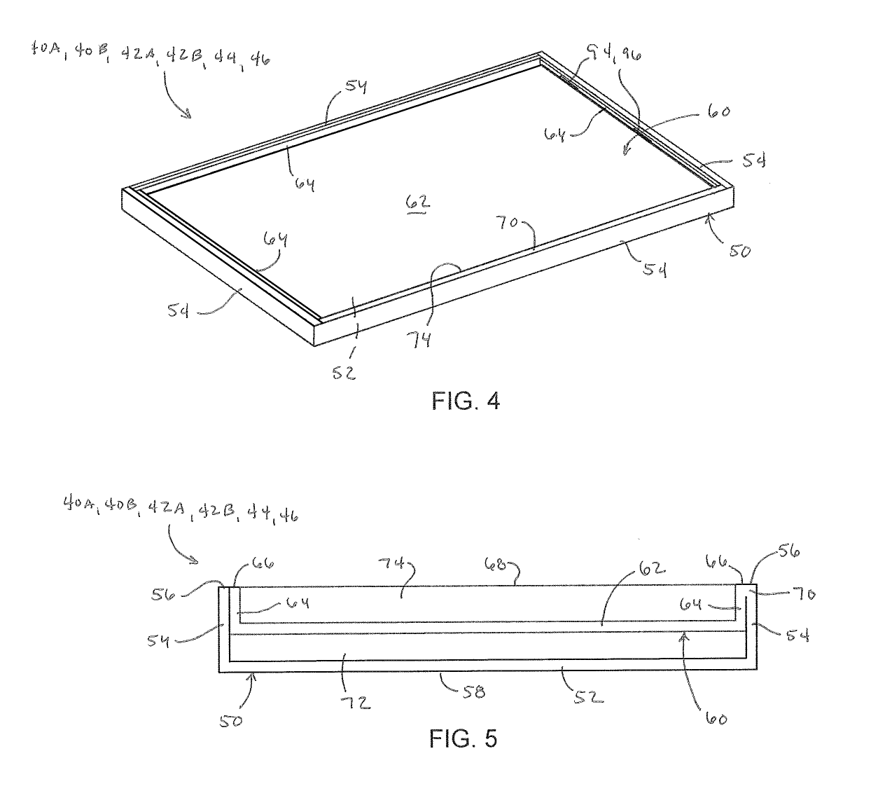

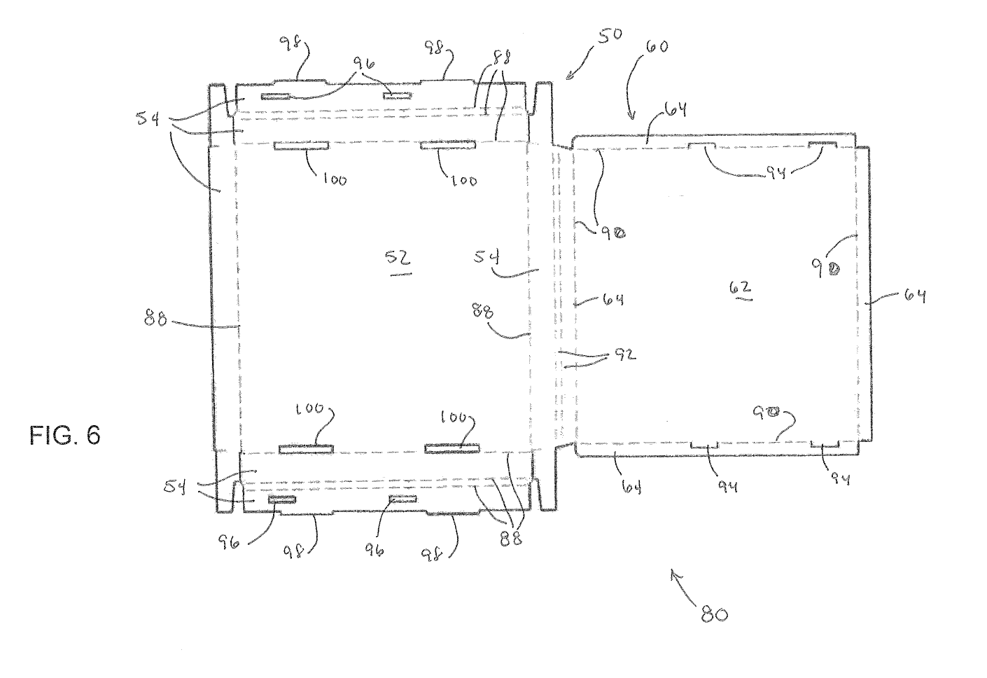

Once fabricated, the insert panels 40A, 40B, 42A, 42B, 44, and 46 will differ in size depending on the dimensions of the container 10, but otherwise have similar configurations, and therefore will be described in reference to a typical configuration represented in FIGS. 4 and 5. In particular, each insert panel 40A, 40B, 42A, 42B, 44, and 46 has a “tray” portion 50 comprising a base wall 52 surrounded by four upstanding edge walls 54, and a lid portion 60 comprising a base wall 62 surrounded by four upstanding edge walls 64. An exterior exposed surface of each base wall 52 of the tray portions 50 is disposed at and defines what will be referred to as an inner face 58 of its insert panel 40A, 40B, 42A, 42B, 44, and 46. The tray and lid portions 50 and 60 may be formed from separate blanks, separately fabricated (folded, etc.), and then assembled together by nesting the lid portion 60 in the tray portion 50 so that the edge walls 64 of the lid portion 60 are adjacent and preferably flush with the edge walls 54 of the tray portion 50. Alternatively, as depicted with the embodiment of FIGS. 3 through 5, the tray and lid portions 50 and 60 may be formed from a single unitary blank, a representative blank 80 of which is depicted in FIG. 6. In the embodiment shown in FIGS. 3 through 5, the lid portion 60 is connected by a fold 70 to one of the edge walls 54 of the tray portion 50 such that the lid portion 60 can be folded over and inserted into the tray portion 50 so that its edge walls 64 are adjacent and preferably flush with the edge walls 54 of the tray portion 50, with one of the edge walls 64 defined by the fold 70 that connects the lid portion 60 to the tray portion 50. The edge walls 54 and 64 are disposed at the perimeters of the base walls 52 and 62 of their respective tray or lid portion 50 and 60, and are shown in the drawings as being perpendicular to the base walls 52 and 62.

The lid portion 60 represented in FIGS. 3, 4 and 5 is not inserted into the tray portion 50 so that its base wall 62 is flush with or abuts the base wall 52 of the tray portion 50. Instead, the base walls 52 and 62 are spaced apart to define therebetween an enclosed cavity or compartment, referred to herein as a pocket 72, as seen in FIG. 5. As represented in FIGS. 3 and 5, the base walls 52 and 62 of the tray and lid portions 50 and 60 are parallel to each other and to the fold 70 that connects the lid portion 60 to the tray portion 50. Each insert panel 40A, 40B, 42A, 42B, 44, and 46 also comprises an “air dam” defined as a recessed pocket 74 in one face thereof. As evident from FIG. 5, the recessed pocket 74 is surrounded by the edge walls 54 and 64 of the tray and lid portions 50 and 60, and located between the base wall 62 of the lid portion 60 and a plane containing the upper edges 56 and 66 of the edge walls 54 and 64 of the tray and lid portions 50 and 60. As such, the recessed pocket 74 and the surrounding edges 56 and 66 of the tray and lid portions 50 and 60 are disposed at and define what will be referred to as an outer face 68 of its insert panel 40A, 40B, 42A, 42B, 44, and 46. The edge walls 64 of the lid portion 60 are represented as being approximately half the height of the edge walls 54 of the tray portion 50, such that when the lid portion 60 is folded over and into the tray portion 50, the enclosed pocket 72 is roughly one-half of the height of the tray portion 50, and the recessed pocket 74 accounts for the remaining height of the tray portion 50.

The enclosed and recessed pockets 72 and 74 are notable features that enable tailoring of the insulation capabilities of the insert panels 40A, 40B, 42A, 42B, 44, and 46 and the system 30 as a whole. As will be discussed below, an insulation material, for example, a fluff material, can be contained in the enclosed pocket 72 and sufficiently compressed between the base walls 52 and 62 of the tray and lid portions 50 and 60 to inhibit settling, whereas the recessed pocket 74 can remain unfilled (i.e., filled only with air). This combination is believed to achieve an insulation capability suitable for replacing conventional prior art systems that use, for example, polystyrene (“Styrofoam”) panels, peanuts, and other standard container insulation materials.

Each insert panel 40A, 40B, 42A, 42B, 44, and 46 can be fabricated by folding its corresponding blank 80 according to known practices in the industry, as exemplified in FIG. 6 by the use of scores 88 located between the base and edge walls 52 and 54 of the tray portion 50, scores 90 located between the base and edge walls 62 and 64 of the lid portion 60, and one or more scores 92 located between the adjoining edge walls 54 and 64 of the tray and lid portions 50 and 60 used to define the fold 70. FIG. 6 also represents the blanks 80 as comprising complementary tabs 94 and slots 96 defined in, respectively, the edge walls 64 of the lid portion 60 and the edge walls 54 of the tray portion 50 that are oriented perpendicular to the scores 92 that define the fold 70. The tabs 94 in the edge walls 64 of the lid portion 60 are adapted to engage the slots 96 in the edge walls 54 of the tray portion 50 when the lid portion 60 is folded over and into the tray portion 50, thereby securing the lid portion 60 to the tray portion 50 as well as establishing and maintaining the position of the lid portion 60 within the tray portion 50, which also establishes and maintains the volumes of the enclosed and recessed pockets 72 and 74.

FIG. 6 further represents the blanks 80 as comprising complementary tabs 98 and slots 100 utilized to construct the tray portion 50, and particularly the edge walls 54 of the tray portion 50 that are parallel to each other and perpendicular to the fold 70. These edge walls 54 are constructed by twice folding the walls 54 along the scores 88 formed in the walls 54. The tabs 98 are disposed at the edges of these walls 54 and the slots 100 are located in one of the scores 88 disposed between the walls 54 and the base wall 52 of the tray portion 50, such that after twice folding each wall 54 the tabs 98 engage the slots 100 to secure the walls 54 in their folded configuration.

It can be mentioned here that, if the tray and lid portions 50 and 60 are formed from separate blanks as was noted above, such blanks might resemble the two portions of the blank 80 that would result from eliminating the material between the scores 92 that define the fold 70.

According to preferred aspects of the invention, the enclosed pocket 72 of each insert panel 40A, 40B, 42A, 42B, 44, and 46 can be filled with an insulation material 76 of any suitable type. Preferred insulation materials are recyclable for the purpose of the system 30 being entirely manufactured from recyclable materials. Preferred insulation materials include solid but loose fill materials (“fluff”), nonlimiting examples of which include shredded solid materials such as shredded waste paper, shredded newspaper, cotton fiber, shredded coconut husks, shredded and pulped corrugated clippings, shredded used corrugated boxes, other shredded cellulosic materials, and other light weight and flexible materials. The insulation material 76 is effectively locked in place within the enclosed pocket 72 as a result of the manner in which the lid portion 60 is folded over and into the tray portion 50 and locked in place with the tabs 94, as well as the compression of the insulation material 76 that occurs between the base walls 52 and 62 as the lid portion 60 is locked in place. In contrast, the recessed pockets 74 of the insert panels 40A, 40B, 42A, 42B, 44, and 46 are preferably not filled with any material, such that each recessed pocket 74 is predominantly and preferably entirely filled with air, defining an insulative air-filled pocket that is present within the container 10 between the lid portions 60 of the insert panels 40A, 40B, 42A, 42B, 44, and 46 and the container panels 14A, 14B, 14C and 14D, bottom wall 16, and top wall 18 of the container 10. Optionally, any of the recessed pockets 74 of the insert panels 40A, 40B, 42A, 42B, 44, and 46 could be filled with an insulation material, and/or insulation material could be omitted from any of the enclosed pockets 72 such that each unfilled enclosed pocket 72 defines an additional air-filled pocket within the container 10.

The relative dimensions of the edge walls 54 and 64 of the tray and lid portions 60 and the locations of their tabs 94 and slots 96 can be tailored to modify the relative internal volumes of the enclosed pockets 72 and recessed pockets 74 within the insert panels 40A, 40B, 42A, 42B, 44, and 46, which in turn can be used to tailor the thermal properties of the insulated package system 30 in view of the presence or absence of insulation material. In some embodiments, it may be desirable for the recessed pocket 74 to be eliminated, for example, by eliminating the edge walls 64 of the lid portion 60 so that the edge walls 54 of the tray portion 50 and the base walls 52 and 62 of the tray and lid portions 50 and 60 create an enclosed pocket 72 whose height is equal to the height of the edge walls 54 between the base walls 52 and 62.

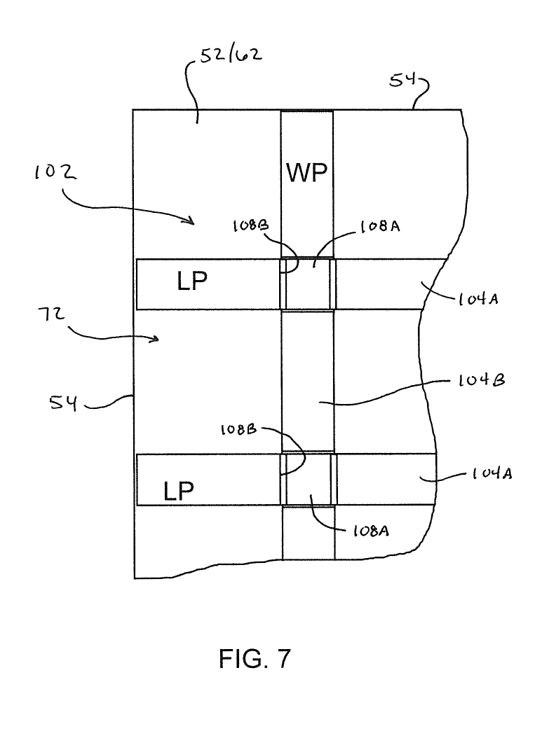

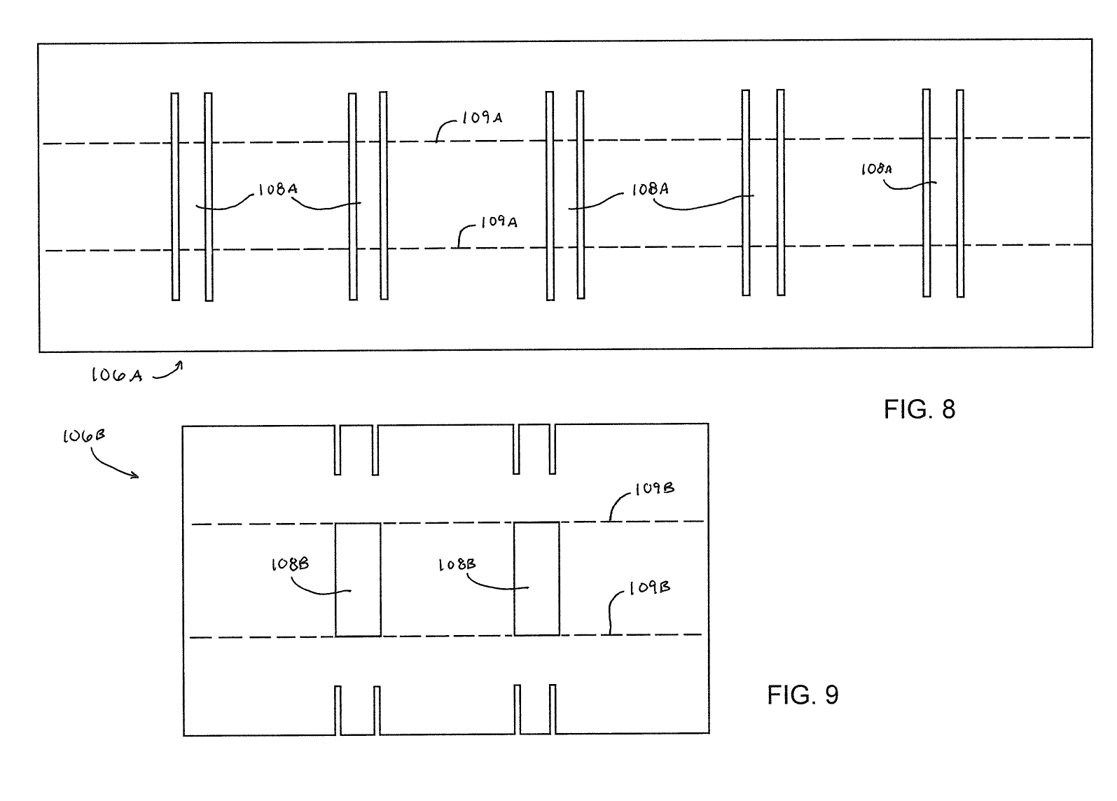

In embodiments in which the recessed pocket 74 has been eliminated from the bottom insert panel 44, the structural strength of the panel 44 can be promoted by placing a reinforcement structure within its enclosed pocket 72. A fragmentary portion of such a structure is represented in FIG. 7 as an interlocking grid structure 102 that comprises transverse interlocking lengthwise and widthwise members 104A and 104B. The members 104A and 104B can be constructed from blanks 106A and 106B depicted in FIGS. 8 and 9. The blanks 106A and 106B are fabricated to have scores 109A and 109B that enable the blanks 106A and 106B to be folded to achieve substantially identical U-shaped cross-sections for the members 104A and 104B. In the embodiments represented, the widthwise members 104B are fabricated to include one or more cutouts 108B located so that, after assembly with one or more lengthwise members 104A, a bridge portion 108A of each lengthwise member 104A is received in a corresponding one of the cutouts 108B, creating a desired interlocking effect between the members 104A and 104B that maintains the grid pattern of the structure 102 while the structure 102 is contained within the enclosed pocket 72. In the embodiment of FIGS. 8 and 9, the lengthwise and widthwise members 104A and 104B are configured so that two lengthwise members 104A can be assembled and interlocked with five widthwise members 104B, though the grid structure 102 could be configured to comprise any number of members 104A and 104B. It should be further noted that, though the grid structure 102 is particularly well suited for promoting the strength of a bottom insert panel 44 that lacks a recessed pocket 74, the grid structure 102 could be employed in any insert panel within the scope of the invention, and could be placed in either or both of the enclosed and recessed pockets 72 and 74 to promote the structural strength of the panel.

The following is a preferred but nonlimiting procedure for installation of the insert panels 40A, 40B, 42A, 42B, 44, and 46 in the container 10. The bottom insert panel 44 is first placed in the bottom of the container 10 so that its inner face 58 faces upward and inward into the interior volume 12, its recessed pocket 74 and outer face 68 face downward toward the bottom wall 16 of the container 10, its edges 56 and 66 contact the bottom wall 16, and its edge walls 54 contact the container panels 14A, 14B, 14C and 14D of the container 10. As such, the width and length of the bottom insert panel 44 are substantially equal to the interior widthwise and lengthwise dimensions of the container 10 (respectively, between its panels 14A and 14B and between its panels 14C and 14D).

The two side insert panels 40A and 40B (represented as longer than the end insert panels 42A and 42B) are then preferably placed within the interior volume 12 of the container 10 along the container panels 14A and 14B, with their respective inner faces 58 facing inward into the interior volume 12, their recessed pockets 74 and outer faces 68 facing outward toward the container panels 14A and 14B, their edges 56 and 66 contacting the container panels 14A and 14B, and one of their edge walls 54 contacts the base wall 52 of the bottom insert panel 44. The lengths of the side insert panels 40A and 40B are preferably equal to the interior lengthwise dimension of the container 10 (between its panels 14C and 14D).

The two end insert panels 42A and 42B are then installed so that they are between the side insert panels 40A and 40B, their respective inner faces 58 face inward into the interior volume 12, their recessed pockets 74 and outer faces 68 face outward toward the container panels 14C and 14D, their edges 56 and 66 contact the container panels 14C and 14D, and one of their edge walls 54 contacts the base wall 52 of the bottom insert panel 44. As such, the width of each end insert panel 42A and 42B is less than the interior widthwise dimension of the container 10 (between its panels 14A and 14B). The side, end and bottom insert panels 40A, 40B, 42A, 42B, and 44 are preferably sized to ensure minimal air gaps therebetween to reduce potential thermal loss from gaps between the panels 40A, 40B, 42A, 42B, and 44.

The top insert panel 46 can be the same size as the bottom insert panel 44, such that its width and length are approximately equal to the interior widthwise and lengthwise dimensions of the container 10 (respectively, between its panels 14A and 14B and between its panels 14C and 14D). As a result, the top insert panel 46 is sized to nest closely within the container 10 and contact the adjacent edge walls 54 of the side and end insert panels 40A, 40B, 42A, and 42B. The top insert panel 46 is placed in the top of the container 10 so that its inner face 58 faces downward and inward toward the interior volume 12, its recessed pocket 74 and outer face 68 face upward toward the top wall 18 of the container 10, its edges 56 and 66 contact the top wall 18 after the flaps 18A-D of the container 10 close the container 10. Within the container 10, the insert panels 40A, 40B, 42A, 42B, and 46 define the insulated shipping compartment 48 (FIG. 3).

While the invention has been described in terms of specific embodiments, it is apparent that other forms could be adopted by one skilled in the art. For example, the physical configurations of the container 10 and insert panels 40A, 40B, 42A, 42B, and 46 could differ from those shown, and materials and processes/methods other than those noted could be used. Therefore, the scope of the invention is to be limited only by the following claims.

1. Insert panels configured to be disposed within an interior volume of a container alongside walls thereof so as to define and enclose an insulated shipping compartment within the interior volume, at least a first of the insert panels comprising:
a tray portion having a base wall that defines an inner face of the first insert panel;
a lid portion having a base wall at an outer face of the first insert panel, the outer face being oppositely-disposed to the inner face of the first insert panel; and
an enclosed pocket disposed between the base walls of the tray and lid portions and within the first insert panel.

2. The insert panels according to claim 1, wherein at least the first insert panel further comprises an interlocking grid structure comprising transverse interlocking lengthwise and widthwise members within the enclosed pocket thereof.

3. The insert panels according to claim 1, wherein at least the first insert panel further comprises an insulation material within the enclosed pocket thereof.

4. The insert panels according to claim 3, wherein the insulation material is a fluff material.

5. The insert panels according to claim 4, wherein the insulation material is compressed between the base walls of the tray and lid portions of the first insert panel.

6. The insert panels according to claim 1, wherein the base wall of the lid portion of the first insert panel defines a recessed pocket that is exposed at the outer face thereof.

7. The insert panels according to claim 6, wherein the recessed pocket does not contain a fluff insulation material.

8. The insert panels according to claim 6, wherein the recessed pocket contains an insulation material.

9. The insert panels according to claim 1, wherein the tray and lid portions of at least the first insert panel are joined by a fold formed in an edge wall thereof, and the lid portion is folded over and into the tray portion to define the fold and the enclosed pocket.

10. The insert panels according to claim 9, wherein the base walls of the tray and lid portions of the first insert panel are parallel to each other and to the fold.

11. The insert panels according to claim 9, wherein the edge wall is a first of a plurality of edge walls of the first insert panel, and the plurality of edge walls are disposed at perimeters of the base walls and are perpendicular to the base walls.

12. The insert panels according to claim 9, wherein the edge wall is a first of a plurality of edge walls of the first insert panel, each of the plurality of edge walls comprises an edge wall of the tray portion and an edge wall of the lid portion that abut and are parallel to each other, the edge walls of the lid portion are disposed at a perimeter of the base wall of the lid portion and are oriented perpendicular to the base wall of the lid portion, and the edge walls of the tray portion are disposed at a perimeter of the base wall of the tray portion, are oriented perpendicular to the base wall of the tray portion, and surround the edge walls of the lid portion.

13. The insert panels according to claim 1, wherein insert panels are disposed within an interior volume of a container alongside walls thereof so as to define and enclose an insulated shipping compartment within the interior volume, the inner face of the first insert panel faces inward toward the insulated shipping compartment, and the outer face of the first insert panel faces outward toward and contacts one of the walls of the container.

14. A method of constructing the insert panels according to claim 1, the method comprising:
constructing the first insert panel by folding the lid portion thereof over and into the tray portion thereof to define a fold in an edge wall thereof and create the enclosed pocket between the base walls of the tray and lid portions thereof.

15. The method according to claim 14, the method further comprising:
placing an insulation material in the tray portion of the first insert panel before folding the lid portion thereof, the insulation material being enclosed and compressed within the enclosed pocket between the base walls of the tray and lid portions thereof after the lid portion is folded over and into the tray portion.

16. The method according to claim 14, wherein the folding of the lid portion over and into the tray portion results in the base wall of the lid portion defining a recessed pocket that is exposed at the outer face of the first insert panel.

17. An insulated package system comprising:
a container having container side panels, container end panels, a closed bottom wall, and an opening closable with a top wall to enclose an interior volume of the container; and
insert panels that are disposed within the interior volume of the container alongside the container side panels, container end panels, bottom wall, and top wall of the container so as to define and enclose an insulated shipping compartment within the interior volume, each of the insert panels comprising a tray portion, a lid portion, and oppositely-disposed inner and outer faces, the inner faces facing inward toward the insulated shipping compartment, the outer faces facing outward toward a corresponding one of the container side panels, container end panels, bottom wall, and top wall of the container, the tray portion having a base wall that defines the inner face of its corresponding insert panel, the lid portion having a base wall at the outer face of its corresponding insert panel, the base walls of the tray and lid portions of at least a first of the insert panels defining therebetween an enclosed pocket within its corresponding insert panel.

18. The insulated package system according to claim 17, wherein the first insert panel further comprises an interlocking grid structure comprising transverse interlocking lengthwise and widthwise members within the enclosed pocket thereof.

19. The insulated package system according to claim 17, wherein the first insert panel further comprises an insulation material within the enclosed pocket thereof.

20. The insulated package system according to claim 19, wherein the insulation material is a fluff material.

21. The insulated package system according to claim 20, wherein the insulation material is compressed between the base walls of the tray and lid portions of the first insert panel.

22. The insulated package system according to claim 20, wherein the base wall of the lid portion of the first insert panel defines a recessed pocket that is exposed at the outer face thereof.

23. The insulated package system according to claim 22, wherein the recessed pocket of the first insert panel does not contain the fluff insulation material.

24. The insulated package system according to claim 22, wherein the recessed pocket of the first insert panel contains an insulation material.

25. The insulated package system according to claim 17, wherein the tray and lid portions of at least a first of the insert panels are joined by a fold formed in an edge wall thereof, and the lid portion is folded over and into the tray portion to define the fold and the enclosed pocket.

26. The insulated package system according to claim 25, wherein the base walls of the tray and lid portions of the first insert panel are parallel to each other and to the fold.

27. The insulated package system according to claim 25, wherein the edge wall is a first of a plurality of edge walls of the first insert panel, and the plurality of edge walls are disposed at perimeters of the base walls and are perpendicular to the base walls.

28. The insulated package system according to claim 25, wherein the edge wall is a first of a plurality of edge walls of the first insert panel, each of the plurality of edge walls comprises an edge wall of the tray portion and an edge wall of the lid portion that abut and are parallel to each other, the edge walls of the lid portion are disposed at a perimeter of the base wall of the lid portion and are oriented perpendicular to the base wall of the lid portion, and the edge walls of the tray portion are disposed at a perimeter of the base wall of the tray portion, are oriented perpendicular to the base wall of the tray portion, and surround the edge walls of the lid portion.

29. A method of constructing the insulated package system of claim 17, the method comprising:
placing a first of the insert panels within the interior volume of the container along the bottom wall so that the inner face thereof faces upward and inward into the interior volume, and the outer face thereof face downward toward the bottom wall of the container;
placing second and third of the insert panels within the interior volume of the container along the container side panels so that the respective inner faces thereof face inward into the interior volume, the respective outer faces thereof face outward toward the container side panels, and one of the respective edge walls thereof contacts the first insert panel;
placing fourth and fifth of the insert panels within the interior volume of the container along the container end panels so that the respective inner faces thereof face inward into the interior volume, the respective outer faces thereof face outward toward the container end panels, one of the respective edge walls thereof contacts the first insert panel, and the fourth and fifth insert panels are between the second and third insert panels;
placing a sixth of the insert panels within the interior volume of the container so that the inner face thereof faces downward and inward into the interior volume, the outer face thereof face upward, and the sixth panel contacts the second, third, fourth and fifth insert panels; and then
closing the opening of the container with the top wall thereof.

30. The method according to claim 29, the method further comprising constructing each of the first, second, third, fourth, fifth, and sixth insert panels by folding the lid portion thereof over and into the tray portion thereof to define a fold in an edge wall thereof and create the enclosed pocket between the base walls of the tray and lid portions thereof.

31. The method according to claim 30, the method further comprising placing an insulation material in the tray portion of at least one of the first, second, third, fourth, fifth, and sixth insert panels before folding the lid portion thereof, and the insulation material is enclosed and compressed within the enclosed pocket between the base walls of the tray and lid portions thereof after the lid portion is folded over and into the tray portion.
